(19) United States
(12) Patent Application Publication
(10) Pub. No.: US 2015/0115025 A1
(43) Pub. Date: Apr. 30, 2015

(54) System and Method of Monitoring a Region

(71) Applicant: Honeywell International Inc., Morristown, NJ (US)

(72) Inventors: JunSeong PARK, Seoul (KR); SangHoon Hur, Seoul (KR); Hyungwoo Baek, Seoul (KR)

(73) Assignee: Honeywell International Inc., Morristown, NJ (US)

(21) Appl. No.: 14/065,475

(22) Filed: Oct. 29, 2013

(51) Int. Cl. G06F 17/30

(52) U.S. Cl. CPC G06F 17/30
USPC 235/375

(57) ABSTRACT

A system which provides wireless downloaded information from fixed ambient condition detectors in one or more regions of interest includes a server to which the detectors transmit information pertaining to sensed ambient conditions. Members of a plurality of code elements, with each code element being associated with a respective detector, can be scanned by a wireless device which can then communicate with the server. The server can in turn, download the pre-stored information associated with the respective detector to the wireless device for viewing by a user.

### FIELD

The application pertains to monitoring systems and methods which use wireless smart phones to provide information from detectors. More particularly, the application pertains such systems and methods which enable individuals to monitor outputs from fixed detectors wirelessly from locations displaced from the detectors using wireless smart phones.

### BACKGROUND

Both fixed and portable gas detectors are known and are useful in monitoring various conditions in a region of interest. Fixed detectors provide very cost effective, relatively low maintenance monitoring of such regions. Unfortunately, fixed detectors often do not provide real-time feedback as to conditions being monitored to individuals moving into, or through, the region being monitored as can be provided by portable detectors.

Known types of portable detectors can be carried or worn by individuals in the region of interest. They however, tend to be more expensive than fixed detectors, and require different kinds of detector and battery maintenance programs.

### BRIEF DESCRIPTION OF THE DRAWINGS

FIG. 1 illustrates a block diagram of a system in accordance herewith;

FIG. 2 illustrates additional aspects of the system of FIG. 1; and

FIG. 3 is a flow diagram which illustrates exemplary processing of the system of FIG. 1.

### DETAILED DESCRIPTION

While disclosed embodiments can take many different forms, specific embodiments thereof are shown in the drawings and will be described herein in detail with the understanding that the present disclosure is to be considered as an exemplification of the principles thereof as well as the best mode of practicing same, and is not intended to limit the application or claims to the specific embodiment illustrated.

In one aspect, embodiments hereof provide information wirelessly from detectors fixed in one or more regions of interest via an individual's smart phone. Information from all such detectors can be wirelessly coupled to one or more servers. Each detector is associated with a QR-type scannable code.

An individual, seeking information as to a particular detector can scan a QR code, which might be posted at a location displaced from the subject detector, and forward that request to the one or more servers. The inquiry received from the smart phone can be linked to pre-stored information, at a server, received from the respective detector. That information can then be downloaded to the individual's phone.

Information such as gas or smoke levels, location, alarm status or faults can be stored at the respective server. All such information can be updated on real-time. It will be understood that neither the type of detector nor the exact details, other than as described herein, are limitations hereof.

The detectors can be coupled via a wired or wireless medium to a common control panel which can in turn communicate with the servers. Alternately, the detectors could be Internet enabled and communicate directly with the servers in addition to the control panel.

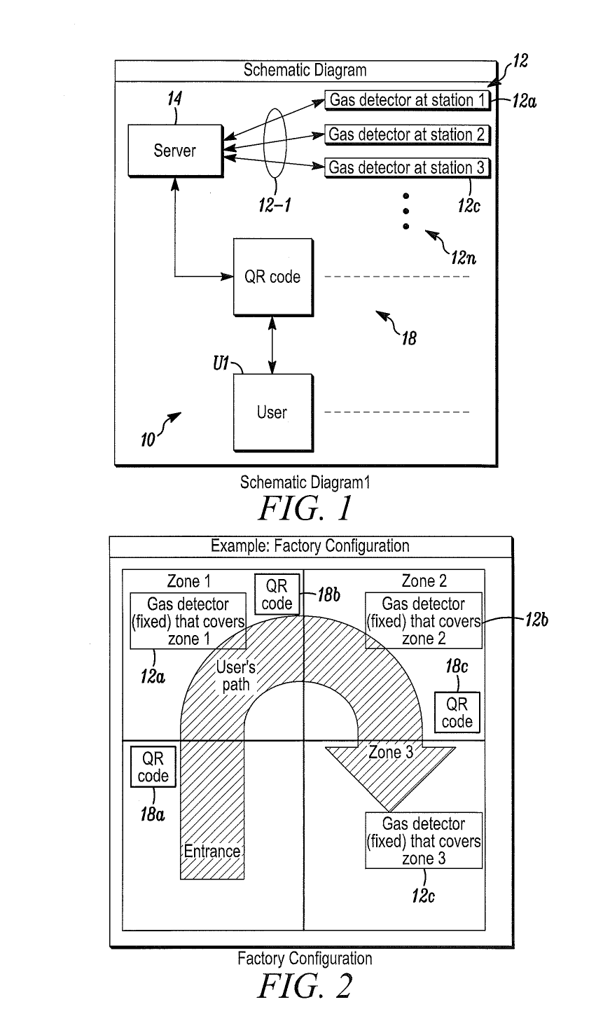

FIG. 1 illustrates a system 10 in accordance herewith. System 10 includes a plurality of detectors 12, which might be gas, smoke, thermal or moisture detectors, which can be installed in each of a plurality of zones of interest, such as zone1, zone2 . . . zonen.

The members of the plurality 12 can communicate via a wired or wireless medium, 12-1 with members of a plurality of servers, such as server 14. A plurality of QR-type code elements illustrated generally at 18 can be associated with members of the plurality 12. The code elements 18 can each include a URL and or associated information pertaining to a respective member of the plurality 12.

A user U1 with a wireless device, such as a smart phone or tablet computer can execute a downloaded app and read a respective one of the code elements 18. The user's inquiry can be transmitted via the smart phone, for example, to the respective server 14. Information pertaining to a respective detector 12i can be downloaded, from server 14, to the smart phone or tablet computer of user U1 providing access to the conditions in a respective zone before the user has entered the respective zone.

FIG. 2 illustrates an exemplary configuration where portions of the system 10, the detectors 12 and representations of the code elements 18 are distributed in a plurality of zones such as zone1, zone2 and zone3. A user's path is illustrated wherein user U1 can access pre-located code elements such as 18i associated with respective zones, before the user enters the respective zone. User U1 can thus safely determine from the information downloaded from server 14 the various conditions, for example smoke or gas levels, in the respective zone before entering same.

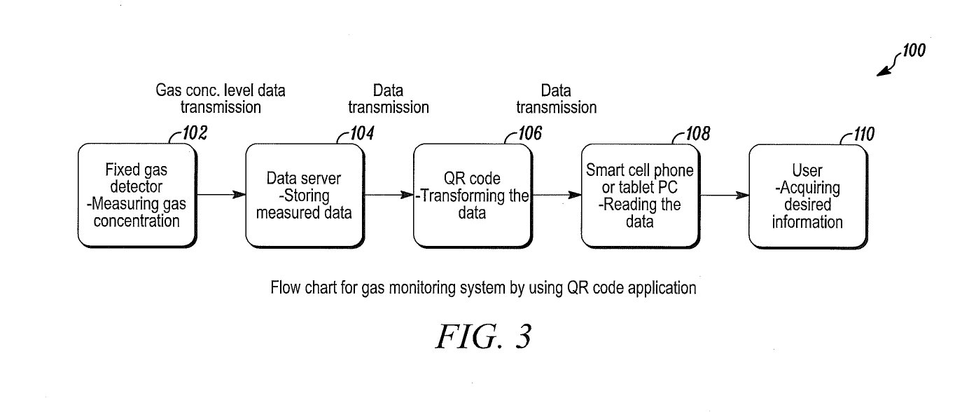

FIG. 3 illustrates an associated process 100. A plurality of detectors can be measuring local information, such as gas or smoke in a respective zone 102. The condition information can be transmitted to as associated server, such as server 14 and stored, as at 104.

Stored data can be associated with a respective code element, as at 106. A user, such as user U1 uses a smart phone or tablet computer to scan the associated code element as at 108 and can review the downloaded information as at 110 before entering the respective zone.

In summary, smartphones or tablet computers can be used instead of portable gas or smoke detectors to safely evaluate conditions in a region. In this regard, fixed detectors can be installed in the region of interest. Sensed information from the various detectors can be forwarded to one or more web servers on a regular basis.

Smoke or gas levels will be updated preferably in real time. QR codes can be used as quick and easy ways to trace a web link. A unique code can be used for each room or a certain area of interest. Users can attach physical copies of respective QR codes adjacent to regions of interest.

The user executes an application to login to the server before they enter the hazardous area. Using the respective QR code, the user can acquire the gas or smoke concentration information for each area before entering the area or zone.

Those of skill will understand that while the exemplary embodiments have been described using QR codes, the claims hereof are not so limited. Other types of codes, including traditional bar codes, and other types of graphical codes without limitation, come within the spirit and scope hereof.

From the foregoing, it will be observed that numerous variations and modifications may be effected without departing from the spirit and scope hereof. It is to be understood that no limitation with respect to the specific apparatus illustrated herein is intended or should be inferred. It is, of course, intended to cover by the appended claims all such modifications as fall within the scope of the claims.

Further, logic flows depicted in the figures do not require the particular order shown, or sequential order, to achieve desirable results. Other steps may be provided, or steps may be eliminated, from the described flows, and other components may be add to, or removed from the described embodiments.

1. A method comprising:
associating a unique coded identifier with each of a plurality of detectors;
locating a representation of each identifier at a respective place displaced from the corresponding detector;
sensing the representation for a selected detector with a wireless device; and
obtaining, via the sensed representation, information pertaining to the respective detector.

2. A method as in claim 1 which includes transmitting data from at least some of the detectors to a common location.

3. A method as in claim 2 wherein data is transmitted by at least one of a wired medium or a wireless medium and which includes locating multi-dimensional bar codes, as representations of each identifier at the respective place.

4. A method as in claim 1 where locating includes providing a coded multi-dimensional representation at the respective place.

5. A method as in claim 4 where locating the coded representation includes forming a quick response-type coded representation.

6. A method as in claim 2 where transmitting includes providing common storage for data from the plurality of detectors.

7. A method as in claim 6 which includes associating a respective coded identifier with data from a respective detector.

8. A method as in claim 7 where locating the coded representation includes displaying one of a quick response-type coded representation, or a bar coded representation.

9. A method as in claim 8 which includes sensing a coded representation for a detector and transmitting real-time data from the common location.

10. A method as in claim 9 which includes downloading respective data to a requesting wireless device.

11. A method as in claim 10 wherein the wireless device comprises at least one of a smart phone, a tablet or wireless computer.

12. An apparatus comprising:
at least one server;
communications circuitry to forward to the server data received from a plurality of detectors monitoring a region wherein each respective detector is associated with a graphical code; and
further circuitry to receive from one or more wireless sources, data requests, each of which is associated with a respective detector and a detector specifying graphical code, and to provide a response to such requests by transmitting data associated with that code and the linked detector to the requesting source.

13. An apparatus as in claim 12 wherein the graphical codes comprise one of a multi-dimensional code, or a bar code.

14. An apparatus as in claim 12 where the server is coupled to the detectors via a computer network.

15. An apparatus as in claim 14 where the detectors are coupled to the server via at least one of a wired or wireless medium.

16. An apparatus as in claim 15 wherein the server stores an identifier of a representative QR code for each detector and associates data for the detector with the stored code.

17. An apparatus as in claim 16 wherein a plurality of multi-dimensional graphical codes is distributed in a region being monitored, wherein each code is associated with at least one detector in the region.

18. An apparatus as in claim 17 wherein each code includes a uniform resource locator associated with the respective detector.

19. An apparatus as in claim 12 where the code comprises one of a QR-type code, or a bar code.

20. A system which provides wireless downloaded information from fixed ambient condition detectors in one or more regions of interest comprises a server to which the detectors transmit information pertaining to sensed ambient conditions, and which includes a plurality of code elements, with each code element being associated with a respective detector, wherein the code elements can be scanned by a wireless device which can then communicate with the server, where the server can in turn, download the pre-stored information associated with the respective detector to the wireless device for viewing by a user.
